(19) United States
(12) Patent Application Publication
(10) Pub. No.: US 2014/0316595 A1
(43) Pub. Date: Oct. 23, 2014

(54) Advanced Measurement and Verification of Energy Curtailment

(71) Applicants: Bradley Kayton, Hollis, NH (US); Jon Rappaport, Mathews, NC (US)

(72) Inventors: Bradley Kayton, Hollis, NH (US); Jon Rappaport, Mathews, NC (US)

(21) Appl. No.: 14/132,627

(22) Filed: Dec. 18, 2013

Related U.S. Application Data
(60) Provisional application No. 61/740,235, filed on Dec. 20, 2012.

(51) Int. Cl. H02J 4/00; G06Q 50/06

(52) U.S. Cl. CPC H02J 4/00; G06Q 50/06
USPC 700/291; 700/295

(57) ABSTRACT

A logic ladder is utilized for conducting Advanced Measurement and Verification (M&V) of energy utilizing devices under curtailment control as part of organized energy management and/or demand response programs. The logic ladder starts with the most accurate method of conducting M&V and steps down from there: first step is measuring energy current directly at the device itself; the second step is use of an Appliance Codes datastore, which are listed capabilities of devices under load control to be used as a proxy if direct measurement of energy consumed at the device is not available; the third step is to poll the smart meter, if it is installed, and taking the energy differential before and immediately after curtailment; and the fourth step is to resort to analytics and historical model estimates of energy curtailment. Appliance Codes consist of a set of parameters that describe the energy utilizing device or appliance under load control, most notably the wattage used when in operation. By approximating the wattage when the device is in operation, one can accurately estimate the wattage under curtailment by simply knowing when the energy utilizing device was turned off and when it was allowed to come back on again after the energy curtailment event.

### CROSS-REFERENCE TO RELATED APPLICATIONS

The present application claims the benefit of U.S. Provisional Application No. 61/740,235, filed on Dec. 20, 2012, incorporated by reference herein and for which benefit of the priority date is hereby claimed.

### FEDERALLY SPONSORED RESEARCH

Not applicable.

### SEQUENCE LISTING OR PROGRAM

Not applicable.

### FIELD OF INVENTION

The present invention relates to a comprehensive system to measure energy that is curtailed, when called for by an energy service provider, and used to verify the energy savings. This curtailment is executed by electric utilities, aggregators of energy savings, and related players in the energy delivery and management sector with the desire of being monetizable, such as biddable into the energy wholesale market or achieving targets that lower the cost of energy delivery.

### BACKGROUND OF THE INVENTION

Measurement & Verification (M&V) of curtailed energy is important as this energy saved is paid for by electric utilities to their customers, or with proper M&V and in certain Independent System Operators/Regional Transmission Organizations (ISOs/RTOs) areas is biddable back into the energy wholesale market. Moreover, this Demand Response (DR) capacity can be used for energy balancing applications requiring precision, such as energy distribution constraint relief or used in the process of intermittent renewables (like wind power or solar power) integration. However, there is a problem in that outside of large commercial or industrial customers, the equipment to do this measurement is cost prohibitive or otherwise not practical. In smaller commercial and residential environments, the M&V mechanisms are either non-existent or very crude, leading to a notable lack of precision, which in turn means DR, and more broadly Demand Side Management (DSM), can't be used for monetizable or precision requirements. Indeed, DR in almost all deployments at this time can be used only for peak load saving, when energy demand is at the level of or overwhelming energy demand, in which precision or exact per facility or per device monetization is not as important. DR used only for peak load shaving is much less valuable than DR that can be used for the additional applications discussed above. In addition, no logical way exists to rank methods of doing M&V, enabling varying levels of accuracy, potentially as part of the same system in a local area, providing varying levels of capabilities of the curtailment.

Currently, curtailment is either estimated by simulations and models of the aggregate population, or measured by the use of a smart meter on or in the facility. The smart meters are supplied in most cases by the local electric utilities and measure the energy used at particular intervals in the home or business facility. However, these smart meters cannot disaggregate the energy used by energy utilizing devices, measuring only the total energy in that building, thus the mechanism is prone to inaccuracy as one or many other devices in the facility could be on or off at the points of measurement, at the start or end of the DR event. Older one-way systems, using communication technologies like FM radio signals to load controller devices, are even worse in that no measurement is made or returned to the curtailment operator and the utility or aggregator cannot even be sure the device was curtailed at the time it was called. Both the newer two-way smart meter systems and the older one-way systems both can be deployed in a system using analytical models of estimated curtailment, and while the accuracies that can be achieved in the aggregate are viable, these historical models are completely inaccurate at the disaggregated facility or device level.

### SUMMARY OF THE INVENTION

In accordance with the present invention, there is provided a system and method that enables a new, improved, and comprehensive way of doing measurement and verification (M&V) of energy curtailment for demand response (DR) and demand side management (DSM).

In one embodiment of the present invention, there is a logic ladder in the manner of conducting M&V, depending on capability of devices and programs. In another embodiment of the present invention, there are “Appliance Codes” which denote capabilities of devices under load control. In one embodiment of the present invention, the logic ladder is implemented by an energy curtailment component.

The logic ladder begins with the best method for doing energy measurement, which is directly measuring the current flow, measured in wattage (and kW), at the device itself. The device could be a load controller component, which is either a) an external module that plugs into the wall and has a legacy appliance plugged into it able to cut and subsequently resume power to the appliance via a remote controlled relay in the external module, or b) an external module that is wired inline, such as by an electrician, to a legacy appliance and able to cut and subsequently resume power to the appliance via a remote controlled relay in the external module. Or, the energy utilizing device under curtailment control may be an appliance with the networking and metrology silicon chips built into appliance. This method of measuring the energy, and similarly the lack of energy consumed when under curtailment, is the most accurate manner of doing M&V for a particular energy utilizing device under control since the measurement is immediate, accurate, and not subject to confusion from other energy utilizing devices being on or off in the facility at the time of measurement.

The second level in the logic ladder utilizes “Appliance Codes.” Similar to universal remote control IR Codes (for Audio-Video equipment) where a set of numbers represent the functionality of the emitting Infrared, Appliance Codes consist of a set of parameters that describe the energy utilizing device or appliance under load control, most notably the wattage used when in operation. By knowing the wattage when the energy utilizing device is in operation, one can accurately estimate the wattage under curtailment by simply knowing when the energy utilizing device was turned off and when it was allowed to come back on again after the DR or curtailment event.

Appliance codes are binary recordings that can be constructed for any electronically powered energy utilizing device, but will focus primarily on the following devices: central HVAC systems, electric hot water heaters, and pool/spa/pond pumps.

The third level in the logic ladder is utilizing the utility-supplied smart meter, usually installed on the side of the house. This M&V method entails coordinating the timestamps of when the energy utilizing device was curtailed (remotely turned off and then subsequently enabled to resume power consumption) to the whole-home/whole-facility energy reading at the same <start curtailment> and <resume power> timestamps for the energy utilizing device under management and then considering the differential of whole home energy as the wattage saved by the DR or curtailment event, factoring in the duration of the curtailment. This method suffers from being moderate to low in reliability at the individual facility level as the turning on or off of other, non-related energy utilizing devices will affect the energy consumption readings.

The fourth and final step of the logic ladder, in the absence of steps one through three, is to just interpolate the wattage under curtailment via historical models that have been used for the past 30+ years. This is the least accurate methodology and really only enables the sole DR application of peak load shaving curtailment, and with limited accuracy.

One embodiment of the present invention provides a holistic method for measuring energy usage, ranked by order of precision (“the ladder”), which in turn can be used for rank ordered applications depending on the need of the potential precision. The Appliances Codes enable a relatively accurate measurement estimate by knowing in advance, and mapped to each facility/billing entity, the wattage when in operation of the particular energy utilizing device under control. Thus by simply multiplying the wattage by the time under curtailment, one can derive the kWh of savings. While not a requirement, the system can operate with participants utilizing different steps on the M&V ladder for energy program settlement, possibly with the more accurate methods returning more money or other compensated benefit to the energy users/customers willing to adopt this more accurate method.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a block diagram of various functional components.

FIG. 2 is a flow chart of a method for measuring energy usage

FIG. 3 is a block diagram of a system for measuring energy usage.

FIG. 4 is a block diagram of a computer system for implementing a system for measuring energy usage.

FIG. 5 is a block diagram of computer system components.

### DETAILED DESCRIPTION

Before the invention is described in further detail, it is to be understood that the invention is not limited to the particular embodiments described, as such may, of course, vary. It is also to be understood that the terminology used herein is for the purpose of describing particular embodiments only, and not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed with the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, if dates of publication are provided, they may be different from the actual publication dates and may need to be confirmed independently.

It should be further understood that the examples and embodiments pertaining to the systems and methods disclosed herein are not meant to limit the possible implementations of the present technology. Further, although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the Claims.

One embodiment of the present invention includes a datastore; load controller components to achieve on/off of energy utilizing devices, either natively or externally, as well as potentially measuring the energy flowing to/through energy utilizing devices; one or more of the energy utilizing devices types under control such as HVAC, Hot Water Heater, Pool/Spa/Pond Pump; and an energy curtailment component.

A datastore used to capture specific fields of data for types of energy consuming devices can be used predict energy usage of an energy utilizing device on the grid fairly accurately. The datastore of devices can include any energy consuming device, but in most cases will focus on four major device types: Central HVAC, window unit Air Conditioner, Hot Water Heaters, and Pool/Spa/Pond Pumps.

Electronics to achieve load control will be present in the system. The load controller component can be an external load controller that the energy utilizing device plugs into, or attached externally by splicing into the power leads of the energy utilizing device, or is built into the energy utilizing device such as an appliance natively as a “smart appliance.” The load controller component has a relay switch, that can cut off (or resume) power to the energy utilizing device, that is remotely controllable by an energy curtailment component. To measure energy directly at the energy utilizing device, the first step in the M&V ladder, the power current and voltage is measured in the load controller component, usually with the addition of an integrated circuit dedicated to this task.

Centralized Heating, Ventilation, and Air Conditioning (HVAC) systems use a lot of energy in the average home or business, sometimes as much as half of all energy consumed by the entire facility. All four “steps” of the M&V ladder are achievable with HVAC. HVAC systems typically are given a BTU rating and an EER (energy efficiency ratio) rating which can be calculated into the average wattage used as part of the Appliance Code for each and any particular HVAC system under control. Control is obtained by use of an external load controller component, or via a Programmable Control Thermostat (PCT), or embedded natively into the electronics controlling the compressor of a “smart appliance” HVAC system. The HVAC datastore of Appliance Codes, one code for each make/model for systems deployed since 1970 in the United States is estimated to be 1.5 M records.

Electric Hot Water heaters use a lot of energy in the average home or business, often in the range of 20% to 30% consumed by the entire facility. All four “steps” of the M&V ladder are achievable with Hot Water Heaters. Control is obtained by use of an external load controller component or embedded natively into the electronics controlling the “smart appliance” Hot Water Heater system. Remote scheduling of this particular energy utilizing device on a mass scale will allow for advanced DR and Energy Efficiency (EE) programs. The Hot Water Heater datastore of Appliance Codes, one code for each make/model for systems deployed since 1970 in the United States is estimated to be 5000 records.

Pool/Spa/Pond pumps use a lot of energy when in operation, often in the 1.3 kW to 1.6 kW range. All four “steps” of the M&V ladder are achievable with these water Pumps. Control is obtained by use of an external load controller component or embedded natively into the electronics controlling the “smart appliance” pool/spa/pond pumps system. Remote scheduling of this particular energy utilizing device on a mass scale will allow for advanced DR and Energy Efficiency (EE) programs. The pool/spa/pond datastore of Appliance Codes, one code for each make/model for systems deployed since 1970 in the United States is estimated to be a few thousand records.

In one embodiment of the present invention, an energy curtailment component coordinates the on/off signaling of energy utilizing devices. The energy curtailment component most commonly consists of a server which communicates to embedded systems software in the load controller component and/or smart appliance.

In one embodiment of the present invention, a network linkage connects the server to the load controlling component at or in the device. This network linkage is any viable two-way communication system, such as the public Internet.

When a BTU rating is given for a unit, it is the maximum BTU the unit is able to produce. This rating is given for when the unit is cooling when the outside temperature is base-lined at 95° F. outside. So to solve for the wattage usage for hotter summer days as part of the Appliance Codes determination, step two of the M&V ladder, an algorithmic correlation and correction to the normalized 95 degrees as the normal day temperature is employed. For the datastore, where the HVAC system, primarily the compressor operation, when wattage isn't available from documentation or actual measurement in the lab or in the field, it can be derived since BTU can be transformed into watts using the formula: Wattage=BTU/EER.

In one embodiment of the present invention, a datastore of information, in the form of an Appliance Code datastore, is created in order get sufficiently precise curtailment accuracy based on energy utilizing device information only matched with energy utilizing device state information at the time of a DR event. Information for the Appliance Code datastore begins from the original installation or activation of the DR or energy management system, the installer or user chooses the make/model, age, and other energy utilizing device information which is recorded in and mapped to the datastore. An installer could also record the energy consumption when on location during installation or at some time thereafter to be used as the information for that particular energy utilizing device in that particular home or business. Moreover, this information measured from that profiled energy utilizing device can be uploaded to the datastore to be used for future installation. This energy utilizing device information representing the energy utilizing device under curtailment is then used at the time of a DR or energy management related event, providing a wattage estimate of the energy utilizing device over the time duration of a DR event. While direct measurement will clearly be the most accurate, curtailment achieved by use of the Appliance Codes datastore will be almost as accurate as from taking direct energy measurement of the HVAC and will suffice for M&V that energy was curtailed when needed and to the amount curtailed (includes programmatic determination and confirmation of device off/device on commands have been sent and received).

The fields of the Appliance Code datastore for HVAC includes all or some of the following information: product manufacturer, product brand, product model, operating/listed wattage, age of unit since manufacture, age of unit since installation, location of installation of unit, AHRI reference number, model status (available on market, discontinued, supported/not-supported by mfg), OEM source, furnace model, cooling capacity (in btuh), Energy Efficiency Ratio (EER), SEER number, CEE Qualifying tier number, ARI Type, Energy Star (yes/no).

The datastore may also include additional records for the following support information: air conditioner coils, heat pumps and heat pump coils, variable speed mini-split air conditioners, variable speed mini-split heat pumps. For commercial models, the datastore may also include additional records for the following support information: air-cooled chilling packages, central station air-handling units, packaged terminal air-conditioners, packaged terminal heat pumps, room fan-coil air conditioners, single packaged vertical air conditioners, single packaged vertical heat pumps, variable air volume terminals—fan powered, variable air volume terminals—modulating diffuser, variable air volume terminals—non-fan powered.

The aim and logic of DR curtailment for Hot Water Heaters is similar to what has been outlined for HVAC. Direct current measurement, at the energy utilizing device location through use of an external or internal load controller component, is the most precise mechanism of M&V and the first step of the M&V logic ladder. If direct energy measurement is not available to be used in M&V, then the second step of the M&V logic ladder, utilizing the Appliance Code datastore can be implemented. By knowing the wattage that is being conserved for a DR event mapped to the time length of the DR event allows the determination of the verifiable energy curtailed. This is possible because water heaters have heating elements that have a set wattage when they are turned on. If Appliance codes are not used, the third step of the logic ladder, assuming there is a smart meter that presents whole home energy data, can be utilized as discussed above by taking the differential from the smart meter. If none of the three above steps are possible with the M&V logic ladder, the program can resort to inaccurate, historical models.

Algorithmically, there are additional factors to take into consideration for Hot Water Heaters in calculating the energy used when in operation and similarly the energy saved when curtailed. For each tank size, there are a smaller number of usable gallons of hot water. This is because when hot water is taken from the tank, cold water fills the empty space, cooling off the rest of the water. An example is that a 40 gallon hot water heater typically has about 28 gallons of usable hot water. Factored into the energy footprint is t the usable water per tank size and how long the element would take to heat the water again.

In one embodiment of the present invention, a datastore of information, in the form of an Appliance Code datastore, is created in order get sufficiently precise curtailment accuracy based on energy utilizing device information only matched with energy utilizing device state information at the time of a DR event. Information for the Appliance Code datastore begins from the original installation or activation of the DR or energy management system, the installer or user chooses the make/model, age, and other device information which is recorded in and mapped to the datastore. An installer could also record the energy consumption when on location during installation or at some time thereafter to be used as the information for that particular energy utilizing device in that particular home or business. Moreover, this information measured from that profiled device can be uploaded to the datastore to be used for future installation. This energy utilizing device information representing the energy utilizing device under curtailment is then used at the time of a DR or energy management related event, providing a wattage estimate of the energy utilizing device over the time duration of a DR event. While direct measurement will clearly be the most accurate, curtailment achieved by use of the Appliance Codes datastore will be almost as accurate as from taking direct energy measurement of the Hot Water Heater and will suffice for M&V that energy was curtailed when needed and to the amount curtailed (includes programmatic determination and confirmation of device off/device on commands have been sent and received).

A related set of activities for Hot Water Heaters is to put them on wide-scale, coordinated schedules rather than effectuate ad hoc on/off actions. The M&V logic ladder and Appliance Codes system still apply in the same form and function in this manner of energy management.

The fields of the Appliance Code datastore for Hot Water Heaters includes all or some of the following information: product manufacturer, product brand, product model, operating/listed wattage, age of unit since manufacture, age of unit since installation, location of installation of unit, model status (available on market, discontinued, supported/not-supported by mfg), OEM source, water tank volume, water tank factor, first hour rating, input energy, volts, energy factor, and kWh/year rating.

The aim and logic of DR curtailment for Pool/Spa/Pond Pumps (“Pumps” for short) is similar to what has been outlined for HVAC and Hot Water Heaters. Direct current measurement, at the energy utilizing device location through use of an external or internal load controller component, is the most precise mechanism of M&V and the first step of the M&V logic ladder. If direct energy measurement is not available to be used in M&V, then the second step of the M&V logic ladder, utilizing the Appliance Code datastore. By knowing the wattage that is being conserved for a DR event mapped to the time length of the DR event allows the determination of the verifiable energy curtailed. If Appliance codes are not used, the third step of the logic ladder, assuming there is a smart meter that presents whole home energy data, can be utilized as discussed above by taking the differential from the smart meter. If none of the three above steps are possible with the M&V logic ladder, the program can resort to inaccurate, historical models.

A related set of activities for Pumps is to put them on wide-scale, coordinated schedules rather than effectuate ad hoc on/off actions. The M&V logic ladder and Appliance Codes system still apply in the same form and function in this manner of energy management. Pumps have a recommended run time of at least 8 hours per day, and although each household or establishment prefers its own run time, that is easily determined.

The fields of the Appliance Code datastore for Pumps includes all or some of the following information: product manufacturer, product brand, product model, operating/listed wattage, age of unit since manufacture, age of unit since installation, location of installation of unit, model status (available on market, discontinued, supported/not-supported by mfg), OEM source, motor speed RPM, motor design, motor construction, motor service factor, motor efficiency %, pump motor capacity (Total HP), Curve-A gpm Flow, Curve-A Power Watt, Curve-A Energy Factor, Curve-B gpm Flow, Curve-B Power Watt, Curve-B Energy Factor, Curve-C gpm Flow, Curve-C Power Watt, and Curve-C Energy Factor.

The same innovations of the M&V logic ladder and Appliance apply to any electronic energy utilizing device. The most viable additional energy utilizing devices to be used in energy management and curtailment programs include window AC units, refrigerators and freezers, and clothes dryers. Any device consuming electricity could be used in these programs and take advantage of these innovations.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

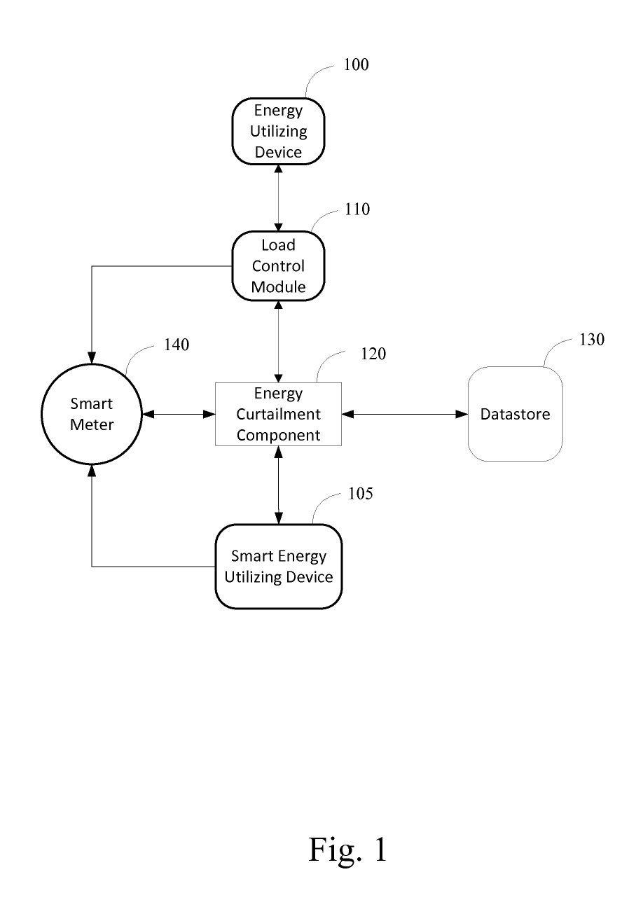

FIG. 1 shows one embodiment of the present invention in which an energy utilizing device 100 is communicatively connected to a load control module 110 and the load control module 110 is communicatively connected to an energy curtailment component 120. In another embodiment, the energy curtailment component 120 is directly communicatively connected to a smart energy utilizing device 105 which has internal capabilities comparable to a load control module 110. In another embodiment of the present invention, the energy curtailment component is connected to a plurality of energy utilizing devices 100 and smart energy utilizing devices 105.

In the event of an energy curtailment event, the energy curtailment component 120 can measure the energy usage of the smart energy utilizing device 105 by receiving usage information directly from the smart energy utilizing device 105. The energy curtailment component 120 can measure the energy usage of an energy utilizing device 100 if such device is connected to a load control module 110 capable of directly monitoring energy usage of the energy utilizing device 100 and transmitting that information directly to the energy curtailment component 120.

Remaining with FIG. 1, the energy curtailment component 120 is communicatively connected to a datastore 130. If the energy curtailment component 120 determines that direct measurement from the smart energy utilizing device 105 or the load control module 110 is not available, then the energy curtailment component 120 will transmit an appliance code representing the energy utilizing device 100 or smart energy utilizing device 105, as the case may be, and the datastore 130 will return a dataset of standardized energy usage for that particular energy utilizing device 100 or smart energy utilizing device 105 from which the energy curtailment component 120 can then calculate the energy usage of the energy utilizing device 100 or smart energy utilizing device 105 for the energy curtailment event.

In one embodiment of the present invention, the energy curtailment component 120 is communicatively connected to a smart meter 140. The smart meter is communicatively connected to a smart energy utilizing device 105, a load control module 110, or to a plurality of such devices. If the energy curtailment component 120 determines that direct measurement from the smart energy utilizing device 105 or the load control module 110 is not available, and that an appliance code is not available for the energy utilizing device 100 or smart energy utilizing device 105, then the energy curtailment component requests two readings from the smart meter 140 for the energy utilizing device 100 or smart energy utilizing device 105, which the smart meter receives directly from the smart energy utilizing device 105 or from the load control module for the energy utilizing device 100. The energy curtailment component 120 requests the first reading from the smart meter 140 at the beginning of the energy curtailment event, and the second reading at the end of the energy curtailment event. From those two reading, the energy curtailment component 120 calculates the energy usage of the energy utilizing device 100 or smart energy utilizing device 105.

Remaining with FIG. 1, if the energy curtailment component 120 determines that direct measurement from the smart energy utilizing device 105 or the load control module 110 is not available, and that an appliance code is not available for the energy utilizing device 100 or smart energy utilizing device 105, and that readings from the smart meter 140 are not available, the energy curtailment component 120 will calculate the energy usage of the energy utilizing device 100 or smart energy utilizing device 105 using historical energy usage models.

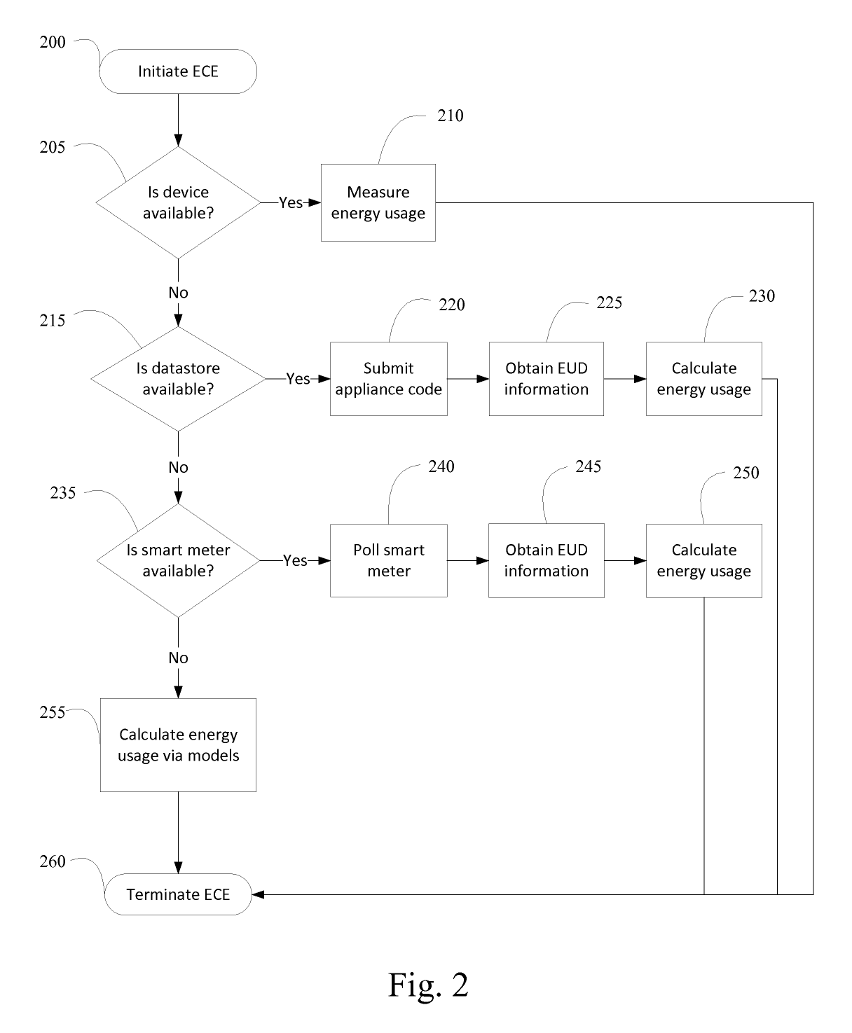

Turning now to FIG. 2, a method of measuring energy usage in an energy curtailment event is shown starting with an energy curtailment event 200. Check to see if access to an energy utilizing device is available 205. If access to energy utilizing device is available 205, then measure the energy usage of the energy utilizing device by receiving usage information directly from the energy utilizing device 210. If access to energy utilizing device is not available 205, then check to see if access to a datastore is available 215. If access to the datastore is available 215, transmit an appliance code representing the energy utilizing device to the datastore 220 and obtain a dataset of standardized energy usage for that particular energy utilizing device 225 and then calculate the energy usage of the energy utilizing device 230.

Remaining with FIG. 2, if an appliance code is not available for the energy utilizing device 215, then check to see if readings from a smart meter is available 235. If readings from a smart meter are available 235, then request two readings from the smart meter 240 for the energy utilizing device, which the smart meter receives directly from either a smart energy utilizing device or from the load control module for a legacy energy utilizing device. The first reading from the smart meter is at the beginning of the energy curtailment event, and the second reading at the end of the energy curtailment event. From those two readings, calculate the energy usage of the energy utilizing device 230.

If readings from a smart meter are not available 235, then calculate the energy usage of the energy utilizing device using historical energy usage models 255.

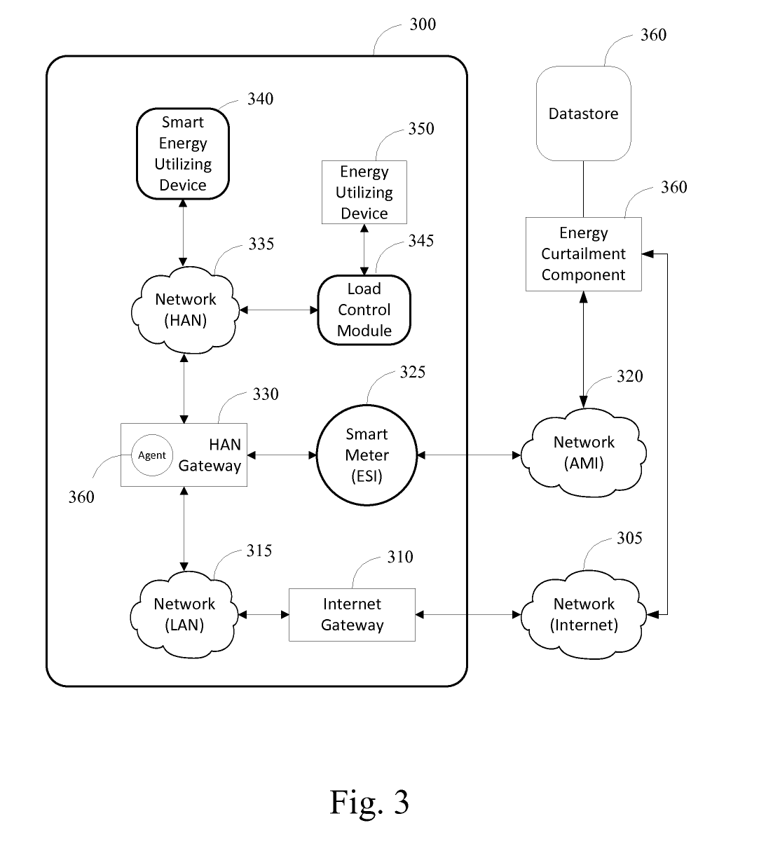

FIG. 3 shows an embodiment where smart energy utilizing devices 340 and energy utilizing devices 350 are located at a facility 300 in an energy curtailment event, a demand-response event is initiated by transmitting a control broadcast message from its server to the consumer facility 300. The control broadcast message can be transmitted to the consumer facility 300 over the public Internet 305, where the control broadcast message is received by the Internet gateway 310 and routed via the Local Area Network 315 to the Home Area Network gateway 330. Alternatively, the control broadcast message can be transmitted to the consumer facility 300 over another network, such as the AMI network 320, where the control broadcast message can be received by the smart meter 325 and routed to the Home Area Network gateway 330.

The Home Area Network gateway 330 routes the control broadcast message over the Home Area Network 335 to smart grid devices 340 and load control modules 345. Smart grid devices 340 will process the received control broadcast message and perform some action, such as modifying its energy consumption. Load control modules 345 will process the received control broadcast message and perform some action such as modifying the energy consumption of an attached legacy device 350.

After performing an action, including the null set of taking no action, the smart grid devices 340 and load control modules 345 report the energy used pursuant to the curtailment demand in the control broadcast message to a software agent 360. The software agent 360 is embedded in the Home Area Network gateway 330 and comprises algorithms and local side control software to achieve the energy program rules and goals. The software agent 360 returns results of the demand-response event to the utility server that initiated the control broadcast message, another server, or an intermediate aggregation node. The software agent 360 can route the results from the Home Area Network gateway 330 over the Local Area Network 315 to the Internet gateway 310. The Internet gateway 310 transmits the data over the Internet 305 to the utility server that initiated the control broadcast message, another server, or an intermediate aggregation node. Alternatively, the software agent 360 can route the results from the Home Area Network gateway 330 to the smart meter 325, which transmits the data over the AMI network 320 to the utility server that initiated the control broadcast message, another server, an intermediate aggregation node.

### Example Computing System

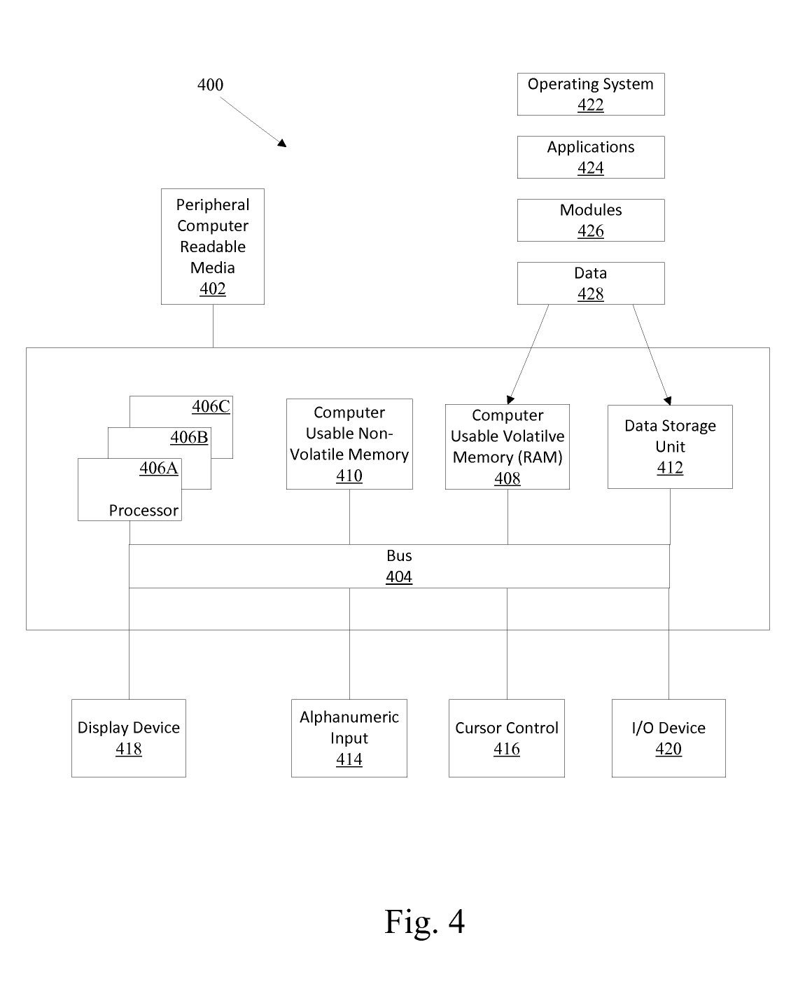

With reference now to FIG.4, portions of the technology for providing computer-readable and computer-executable instructions that reside, for example, in or on computer-usable media of a computer system. That is, FIG. 4 illustrates one example of a type of computer that can be used to implement one embodiment of the present technology.

Although computer system 400 of FIG. 4 is an example of one embodiment, the present technology is well suited for operation on or with a number of different computer systems including general purpose networked computer systems, embedded computer systems, routers, switches, server devices, user devices, various intermediate devices/artifacts, standalone computer systems, mobile phones, personal data assistants, and the like.

In one embodiment, computer system 400 of FIG. 4 includes peripheral computer readable media 402 such as, for example, a floppy disk, a compact disc, and the like coupled thereto.

Computer system 400 of FIG. 4 also includes an address/data bus 404 for communicating information, and a processor 406A coupled to bus 404 for processing information and instructions. In one embodiment, computer system 400 includes a multi-processor environment in which a plurality of processors 406A, 406B, and 406C are present. Conversely, computer system 400 is also well suited to having a single processor such as, for example, processor 406A. Processors 406A, 406B, and 406C may be any of various types of microprocessors. Computer system 400 also includes data storage features such as a computer usable volatile memory 408, e.g. random access memory (RAM), coupled to bus 404 for storing information and instructions for processors 406A, 406B, and 406C.

Computer system 400 also includes computer usable non-volatile memory 410, e.g. read only memory (ROM), coupled to bus 404 for storing static information and instructions for processors 406A, 406B, and 406C. Also present in computer system 400 is a data storage unit 412 (e.g., a magnetic or optical disk and disk drive) coupled to bus 404 for storing information and instructions. Computer system 400 also includes an optional alpha-numeric input device 414 including alpha-numeric and function keys coupled to bus 404 for communicating information and command selections to processor 406A or processors 406A, 406B, and 406C. Computer system 400 also includes an optional cursor control device 416 coupled to bus 404 for communicating user input information and command selections to processor 406A or processors 406A, 406B, and 406C. In one embodiment, an optional display device 418 is coupled to bus 404 for displaying information.

Referring still to FIG. 4, optional display device 418 of FIG. 4 may be a liquid crystal device, cathode ray tube, plasma display device or other display device suitable for creating graphic images and alphanumeric characters recognizable to a user. Optional cursor control device 416 allows the computer user to dynamically signal the movement of a visible symbol (cursor) on a display screen of display device 418. Implementations of cursor control device 416 include a trackball, mouse, touch pad, joystick or special keys on alphanumeric input device 414 capable of signaling movement of a given direction or manner of displacement. Alternatively, in one embodiment, the cursor can be directed and/or activated via input from alphanumeric input device 414 using special keys and key sequence commands or other means such as, for example, voice commands.

Computer system 400 also includes an I/O device 420 for coupling computer system 400 with external entities. In one embodiment, I/O device 420 is a modem for enabling wired or wireless communications between computer system 400 and an external network such as, but not limited to, the Internet. Referring still to FIG. 4, various other components are depicted for computer system 400. Specifically, when present, an operating system 422, applications 424, modules 426, and data 428 are shown as typically residing in one or some combination of computer usable volatile memory 408, e.g. random access memory (RAM), and data storage unit 412. However, in an alternate embodiment, operating system 422 may be stored in another location such as on a network or on a flash drive. Further, operating system 422 may be accessed from a remote location via, for example, a coupling to the Internet. In one embodiment, the present technology is stored as an application 424 or module 426 in memory locations within RAM 408 and memory areas within data storage unit 412.

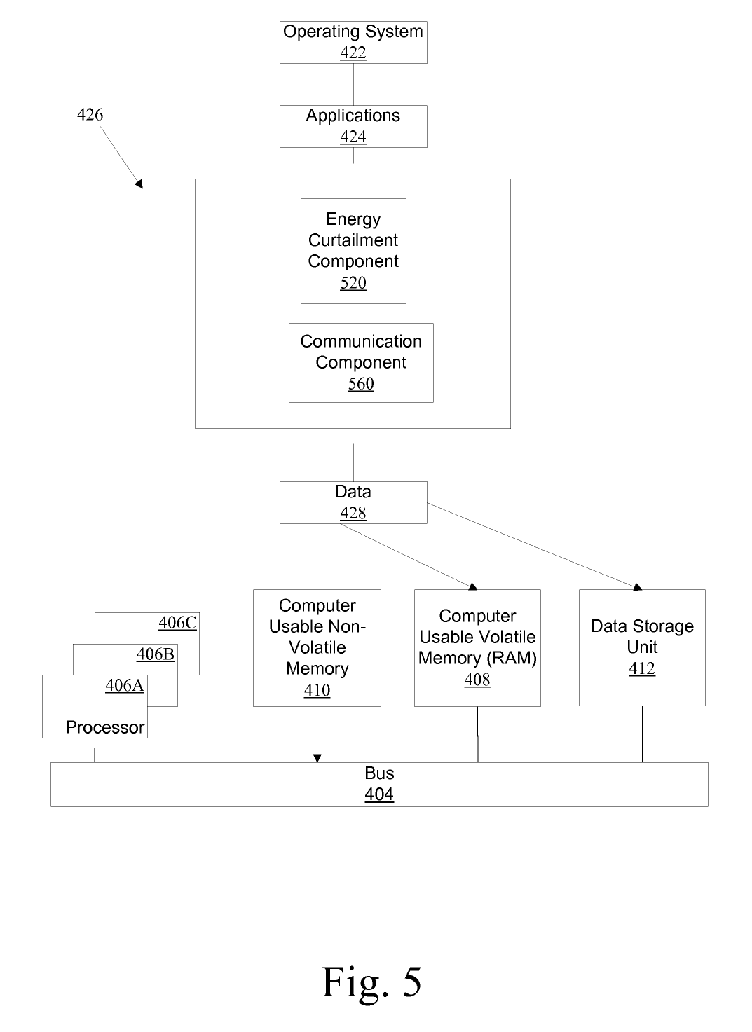

FIG. 5 illustrates the exemplary computing system utilizing specific modules wherein the operating system 422 hosts the application 424 accessing modules 426 manipulating data 428. Modules 426 include the energy curtailment component 520 and communication component 560. Energy curtailment component 520 is configured to receive information from energy utilizing devices, datastores, smart meters and historical model repositories. Data storage unit 412 stores data 428 manipulated by the energy curtailment component 520. Communication component 560 sends communications to interested parties as the energy curtailment event proceeds through the workflow processed by the system.

The present technology may be described in the general context of computer-executable instructions stored on computer readable medium that may be executed by a computer. However, one embodiment of the present technology may also utilize a distributed computing environment where tasks are performed remotely by devices linked through a communications network.

Having thus described the invention, what is desired to be protected by Letters Patent is presented in the subsequently appended claims.

What is claimed is:

1. A system for measuring and verifying energy curtailment, said system comprising:
a. one or more energy utilizing devices;
b. a datastore for storing information relating to said one or more energy utilizing devices;
c. a load controller component for activating or deactivating said energy utilizing devices, said load controller component communicatively connected to said datastore and said one or more energy utilizing devices;
d. an energy curtailment component for determining which of said one or more energy utilizing devices said load controller component should activate or deactivate, said energy curtailment component communicatively connected to said load controller component; and

2. The system of claim 1 further comprising a networked linkage for communicatively connecting said energy curtailment component and said load controller component.

3. The system of claim 1 wherein said load controller component further measures energy flowing into said one or more energy utilizing devices.

4. The system of claim 1 wherein said load controller component further measures energy flowing through said one or more energy utilizing devices.

5. The system of claim 1 wherein said one or more energy utilizing devices comprise one or more devices selected from the group of HVAC, hot water heater, pool pump, spa pump, and pond pump.

6. The system of claim 1 further comprising a plurality of said load controller component.

7. The system of claim 2 wherein said load controller component activates and deactivates said one or more energy utilizing devices externally over said network linkage.

8. A method for measuring and verifying energy curtailment, said method comprising:
a. measuring energy used at an energy utilizing device during an energy curtailment event;
b. if said measurement is unavailable, submitting an appliance code representing said energy utilizing device to a datastore wherein said datastore stores information relating to said energy utilizing device, obtaining said information relating to said energy utilizing device, and calculating energy used by said utilizing device derived from said information relating to said energy utilizing device;
c. if said datastore is unavailable, polling a smart meter communicatively connected to said energy utilizing device before and after said energy curtailment event and calculating energy used by said energy utilizing device derived from said polling;
d. if said smart meter is unavailable, calculating energy used by said energy utilizing device derived from historical model estimates for said energy utilizing device.

9. The method of claim 8 further comprising a plurality of energy utilizing devices;

10. The method of claim 8 wherein a load controller component further measures energy used by said energy utilizing device.

11. The method of claim 8 wherein said energy utilizing device comprises a device selected from the group consisting of HVAC, hot water heater, pool pump, spa pump, and pond pump.
